(19) United States
(12) Patent Application Publication
(10) Pub. No.: US 2026/0197033 A1
(43) Pub. Date: Jul. 9, 2026

(54) SIGNAL PROCESSING APPARATUS, WIRELESS COMMUNICATION SYSTEM, SIGNAL PROCESSING METHOD AND PROGRAM

(71) Applicant: NTT. Inc., Tokyo (JP)

(72) Inventors: Kazumitsu SAKAMOTO, Musashino-shi (JP); Yosuke FUJINO, Musashino-shi (JP); Kohei SUZAKI, Musashino-shi (JP); Yohei KATAYAMA, Musashino-shi (JP); Kenji SUZUKI, Musashino-shi (JP)

(73) Assignee: NTT. Inc., Tokyo (JP)

(21) Appl. No.: 19/132,955

(22) PCT Filed: Nov. 30, 2022
(86) PCT No.: PCT/JP2022/044101

§ 371 Date: May 27, 2025

(51) Int. Cl. H04B 7/01; H04B 7/185

(52) U.S. Cl. CPC H04B 7/01; H04B 7/18513

(57) ABSTRACT

A signal processing device detects a timing of a frame in waveform data based on a sliding correlation between each of the plurality of types of first transmitted known signals obtained by adding different combinations of a first frequency shift and a first frequency variation to the first known signal and the waveform data representing the waveform of the received signal, estimates a Doppler shift and a Doppler variation based on correlation calculation between each of a plurality of types of second transmitted known signals obtained by adding different combinations of the second frequency shift and the second frequency variation to a second known signal and the second known signal in the waveform data specified by a detected timing, and compensates for the estimated Doppler shift and Doppler variation with respect to the waveform data.

### TECHNICAL FIELD

The present invention relates to a signal processing device, a wireless communication system, a signal processing method, and a program.

### BACKGROUND ART

In recent years, satellite Internet of Things (IoT) platforms (satellite IoT-PFs) have been studied. A satellite IoT-PF collects sensor data from IoT terminals anywhere on the Earth using a low earth orbiting satellite. An installation place of the IoT terminal includes an area that is difficult to cover in a terrestrial communication network such as on the sea or in a mountain area.

FIG. 21 is a diagram illustrating a wireless signal received by a low orbit satellite on a satellite IoT-PF. In FIG. 21, a solid arrow represents a desired signal from the satellite IoT terminal, and a broken arrow represents an interference signal from a ground IoT terminal. The satellite IoT terminal is a target for collecting data on the satellite IoT-PF. The low orbit satellite receives not only the desired signals transmitted arriving from a large number of satellite IoT terminals but also a large number of interference signals arriving from the ground IoT terminals widely spread on the ground. Therefore, the satellite IoT-PF requires to extract a weak desired signal transmitted from a desired satellite IoT terminal and perform demodulation and decoding while these signals interfere with each other. As an effective method for this purpose, there is a method of mounting a plurality of reception antennas on a low orbit satellite and performing reception beam control using these reception antennas (see Non Patent Literature 1, for example).

In addition, the low orbit satellite is generally required to be small, lightweight, and power saving. Meanwhile, there are many types of low power wide area (LPWA) methods used by the IoT terminals, such as LoRa (registered trademark), Sigfox (registered trademark), and ELTRES (registered trademark). When the low orbit satellite includes a receiver that performs demodulation and decoding of each LPWA method, the receiver becomes complicated, which leads to an increase in power consumption. Furthermore, a low orbit satellite performing reception beam control, extracting desired signals from a large number of desired satellite IoT terminals and demodulating and decoding the extracted signals also leads to an increase in power consumption since a large amount of signal processing is required in the low orbit satellite. In addition, if a new LPWA method were developed, a low orbit satellite does not include a receiver that is compatible with the LPWA method and thus would not be able to perform normal reception.

Therefore, a system configuration in which a device on the ground performs the reception beam control by offline signal processing has been studied (see Non Patent Literature 2, for example). In this system configuration, a plurality of reception antennas is mounted on a low orbit satellite. The low orbit satellite transmits sampled received waveform data of each reception antenna to the ground. The device on the ground performs the reception beam control for a signal obtained from the received waveform data by offline signal processing to extract the desired signal from the satellite IoT terminal.

When a signal from a satellite IoT terminal on the ground is received by a low earth orbiting satellite, variation with time (hereinafter, Doppler variation) of a Doppler shift accompanying high-speed movement of the satellite becomes a problem. In order to decode the received signal, it is required to estimate and synchronize three elements of the timing, the Doppler shift, and the Doppler variation. However, since the LoRa (registered trademark) terminal has been assumed to be used in an IoT network on the ground so far, the LoRa (registered trademark) receiver is not generally equipped with synchronization processing for compensating for Doppler variations (see, for example, Non Patent Literature 3 and Non Patent Literature 4).

### CITATION LIST

### Non Patent Literature

Non Patent Literature 1: J. Chu, X. Chen, C. Zhong and Z. Zhang, “Robust Design for NOMA-Based Multibeam LEO Satellite Internet of Things”, IEEE Internet of Things Journal, vol. 8, no. 3, pp. 1959-1970, 2021.
Non Patent Literature 2: F. Yamashita, D. Goto, Y. Kojima, M. Matsui, K. Itokawa, K. Yoshizawa, K. Sakamoto, Y. Fujino, C. Kato, and M. Nakadai, “920-MHz IoT platform via LEO satellite employing feeder-link MIMO technology,” Proc. 2020 International Conference on Emerging Technologies for Communications (ICETC2020), A1-2, December 2020.
Non Patent Literature 3: Semtech Corporation, SX1276/77/78/79 Datasheet, Rev. 7, May 2020.
Non Patent Literature 4: P. Robyns, P. Quax, W. Lamotte, and W. Thenaers, “A Multi-Channel Software Decoder for the LoRa Modulation Scheme”, 3rd International Conference on Internet of Things, Big Data and Security (IoTBDS 2018), pp. 41-51, 2018.

### SUMMARY OF INVENTION

### Technical Problem

In a case where a modulated signal of a signal method such as LoRa (registered trademark) in which synchronization processing of Doppler variation compensation is not specified is decoded by offline signal processing in a base station on the ground, it is conceivable to search all the above three elements for the received waveform data. As a result, the optimum timing, the compensation value of the Doppler shift, and the compensation value of the Doppler variation can be detected. However, since the number of combinations is enormous, a very large amount of calculation is required.

In view of the above circumstances, an object of the present invention is to provide a signal processing device, a wireless communication system, a signal processing method, and a program that enable synchronization for decoding a wireless signal while suppressing a load of calculation even under an environment where Doppler variation is large.

### Solution to Problem

An aspect of the present invention is a signal processing device including a timing detection unit that detects a timing of a frame in waveform data based on a sliding correlation between each of a plurality of types of first transmitted known signals obtained by adding different combinations of a first frequency shift corresponding to a Doppler shift and a first frequency variation corresponding to a Doppler variation that is a time variation of the Doppler shift to a first known signal and the waveform data representing a waveform of a received signal in a communication device, and an estimation unit that estimates a Doppler shift and a Doppler variation received by the received signal based on correlation calculation between each of a plurality of types of second transmitted known signals obtained by adding different combinations of a second frequency shift corresponding to a Doppler shift and a second frequency variation corresponding to a Doppler variation to a second known signal and the second known signal in the waveform data specified by the detected timing, and a compensation unit that compensates for the Doppler shift and the Doppler variation estimated for the waveform data.

An aspect of the present invention is a wireless communication system including a transmission device, a relay device, and a reception device, in which the relay device includes a relay unit that receives a signal wirelessly transmitted from the transmission device and transmits waveform data indicating a waveform of the received signal to the reception device, the reception device includes a reception unit that receives the waveform data, a timing detection unit that detects a timing of a frame in the waveform data based on a sliding correlation between each of a plurality of types of first transmitted known signals obtained by adding different combinations of a first frequency shift corresponding to a Doppler shift and a first frequency variation corresponding to a Doppler variation that is a time variation of the Doppler shift to the first known signal and the waveform data, an estimation unit that estimates a Doppler shift and a Doppler variation received by the received signal based on correlation calculation between each of a plurality of types of second transmitted known signals obtained by adding different combinations of a second frequency shift corresponding to a Doppler shift and a second frequency variation corresponding to a Doppler variation to a second known signal and the second known signal in the waveform data specified by the detected timing, and a compensation unit that compensates for the Doppler shift and the Doppler variation estimated for the waveform data.

An aspect of the present invention is a signal processing method including a timing detection step of detecting a timing of a frame in waveform data based on a sliding correlation between each of a plurality of types of first transmitted known signals obtained by adding different combinations of a first frequency shift corresponding to a Doppler shift and a first frequency variation corresponding to a Doppler variation that is a time variation of the Doppler shift to a first known signal and the waveform data representing a waveform of a received signal in a communication device, an estimation step of estimating a Doppler shift and a Doppler variation received by the received signal based on correlation calculation between each of a plurality of types of second transmitted known signals obtained by adding different combinations of a second frequency shift corresponding to a Doppler shift and a second frequency variation corresponding to a Doppler variation to a second known signal and the second known signal in the waveform data specified by the detected timing, and a compensation step of compensating for Doppler shift and the Doppler variation estimated for the waveform data.

An aspect of the present invention is a program causing a computer to function as a timing detection unit that detects a timing of a frame in waveform data based on a sliding correlation between each of a plurality of types of first transmitted known signals obtained by adding different combinations of a first frequency shift corresponding to a Doppler shift and a first frequency variation corresponding to a Doppler variation that is a time variation of the Doppler shift to a first known signal and the waveform data representing a waveform of a received signal in a communication device, an estimation unit that estimates a Doppler shift and a Doppler variation received by the received signal based on correlation calculation between each of a plurality of types of second transmitted known signals obtained by adding different combinations of a second frequency shift corresponding to a Doppler shift and a second frequency variation corresponding to a Doppler variation to a second known signal and the second known signal in the waveform data specified by the detected timing, and a compensation unit that compensates for the Doppler shift and the Doppler variation estimated for the waveform data.

### Advantageous Effects of Invention

According to the present invention, it is possible to perform synchronization for decoding a wireless signal while suppressing a load of calculation even in an environment where a Doppler variation is large.

### BRIEF DESCRIPTION OF DRAWINGS

FIG. 1 A diagram illustrating a configuration of a wireless communication system according to a first embodiment.

FIG. 2 A diagram illustrating a known signal section used in the first embodiment.

FIG. 3 A diagram illustrating whether a head timing is successfully detected according to the first embodiment.

FIG. 4 A diagram illustrating whether the head timing is successfully detected according to the first embodiment.

FIG. 5 A diagram illustrating a Doppler shift and a Doppler variation search result according to the first embodiment.

FIG. 6 A diagram illustrating correlation values for each Doppler variation estimation value according to the first embodiment.

FIG. 7 A flowchart illustrating processing of the wireless communication system according to the first embodiment.

FIG. 8 A flowchart illustrating processing of the wireless communication system according to the second embodiment.

FIG. 9 A flowchart illustrating processing of a signal processing unit according to the first embodiment.

FIG. 10 A diagram illustrating a configuration of a wireless communication system according to a second embodiment.

FIG. 11 A diagram illustrating a search range according to the second embodiment.

FIG. 12 A flowchart illustrating processing of a signal processing unit according to the second embodiment.

FIG. 13 A diagram illustrating a configuration of a wireless communication system according to a third embodiment.

FIG. 14 A diagram illustrating a frequency shift of a symbol due to a Doppler shift according to the third embodiment.

FIG. 15 A diagram illustrating a search range according to the third embodiment.

FIG. 16 A flowchart illustrating processing of a signal processing unit according to the third embodiment.

FIG. 17 A diagram illustrating a configuration of a wireless communication system according to a fourth embodiment.

FIG. 18 A diagram illustrating a search range used in the fourth embodiment.

FIG. 19 A diagram illustrating a search range used in the fourth embodiment.

FIG. 20 A flowchart illustrating processing of a signal processing unit according to the fourth embodiment.

FIG. 21 A diagram illustrating a wireless signal received by a low orbit satellite in a satellite IoT-PF.

### DESCRIPTION OF EMBODIMENTS

Hereinafter, an embodiment of the present invention will be described in detail with reference to the drawings. Note that the same parts will be denoted by the same reference signs in the drawings, and the description thereof will be omitted.

### First Embodiment

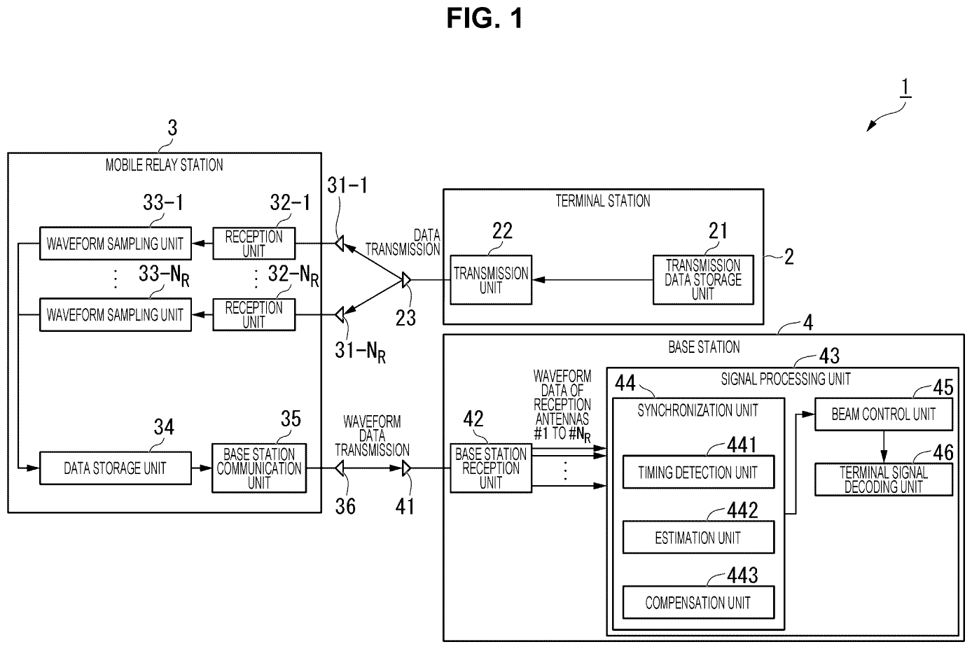

FIG. 1 is a diagram illustrating a configuration of a wireless communication system 1 according to a first embodiment of the present invention. The wireless communication system 1 includes a terminal station 2, a mobile relay station 3, and a base station 4. The base station 4 is an example of a signal processing device. In the wireless communication system 1, the numbers of the terminal stations 2, the mobile relay stations 3, and the base stations 4 are arbitrary. Note that it is supposed that the number of terminal stations 2 is large. The mobile relay station 3 moves through the sky above the earth. The terminal station 2 and the base station 4 are installed on the earth. The earth includes the ground and the sea. Hereinafter, a wireless signal transmitted from the terminal station 2 to the mobile relay station 3 is referred to as an “uplink signal”. Further, wireless signals transmitted from the mobile relay stations 3 to the base stations 4 will be referred to as a “downlink signal”.

The terminal station 2 is, for example, a satellite IoT terminal that performs communication by a wireless method used in a satellite IoT platform. Here, a case where LoRa (registered trademark) is used as the wireless method will be described as an example, but other wireless methods may be used. The terminal station 2 includes a transmission data storage unit 21, a transmission unit 22, and an antenna 23. Although FIG. 1 illustrates an example in which one antenna 23 is provided, two or more antennas 23 may be provided.

The transmission data storage unit 21 stores transmission data. The transmission data is, for example, environment data or the like detected by a sensor. The transmission unit 22 generates the uplink signal in which the transmission data read from the transmission data storage unit 21 is set. The transmission unit 22 transmits an uplink signal from the antenna 23 by LoRa (registered trademark) toward the mobile relay station 3 moving in the sky.

The mobile relay station 3 is an example of a communication device that moves over time. The mobile relay station 3 moves through the sky by being mounted on a moving body. The mobile relay station 3 is provided in, for example, a low earth orbit (LEO) satellite. The mobile relay station 3 travels around the earth along a predetermined orbit. The LEO satellite has an altitude of 2000 km or less and travels around the earth once every about 1.5 hours. The mobile relay station 3 receives the uplink signal from each terminal station 2 while moving through the sky above the earth. The mobile relay station 3 accumulates data received by the uplink signal. The mobile relay station 3 transmits the accumulated data to the base station 4 using the downlink signal at timing at which communication with the base station 4 is possible.

Since the mobile relay station 3 mounted on the LEO satellite performs communication while moving at a high speed, a time during which each terminal station 2 or the base station 4 can communicate with the mobile relay station 3 is limited. Specifically, when viewed on the ground, the mobile relay station 3 passes through the sky in about several minutes. Therefore, the mobile relay station 3 mounted in the LEO satellite has a smaller link budget as compared with a case where the relay station is mounted in a drone or a high altitude platform station (HAPS), for example. Therefore, the mobile relay station 3 receives uplink signals from the terminal stations 2 in coverage at a current position during moving through the plurality of reception antennas and stores waveform data obtained by sampling waveforms of the uplink signals received by the respective reception antennas. For example, multiple input multiple output (MIMO) is used for the reception using the plurality of reception antennas. A communication quality can be improved according to a diversity effect and a beamforming effect in the communication using the plurality of reception antennas.

The mobile relay station 3 includes antennas 31-1 to 31-N_{R} (N_{R} is an integer that is equal to or greater than 2), reception units 32-1 to 32-N_{R}, waveform sampling units 33-1 to 33-N_{R}, a data storage unit 34, a base station communication unit 35, and an antenna 36. Although FIG. 1 illustrates an example in which one antenna 36 is provided, two or more antennas 36 may be provided.

The antennas 31-1 to 31-N_{R} are used for wireless communication with the terminal station 2. The antennas 31-1 to 31-N_{R} correspond to reception antennas of uplink signals. The antenna 31-n (n is an integer between 1 and N_{R}) is also referred to as a reception antenna #n. On the other hand, the antenna 36 is used for wireless communication with the base station 4. A frequency used for wireless communication with the terminal station 2 is generally different from a frequency used for wireless communication with the base station 4. Therefore, the mobile relay station 3 can execute the wireless communication related to the terminal station 2 and the wireless communication related to the base station 4 in parallel.

The reception unit 32-n receives an uplink signal through the antenna 31-n. The waveform sampling unit 33-n samples the reception waveform of the uplink signal received by the reception unit 32-n and stores the waveform data obtained by the sampling in the data storage unit 34. This waveform data is also referred to as waveform data of the reception antenna #n. As the waveform sampling unit 33-n, a commercially available radio frequency (RF) chip can be used. The RF chip used as the waveform sampling unit 33-n down-converts the uplink signal of the RF signal received by the reception unit 32-n, and samples the reception waveform of the down-converted uplink signal. The base station communication unit 35 transmits the downlink signal to the base station 4 at a timing when the base station 4 exists in the coverage. The waveform data read from the data storage unit 34 is set in the downlink signal.

The base station 4 includes an antenna 41, a base station reception unit 42, and a signal processing unit 43. Although FIG. 1 illustrates an example in which one antenna 41 is provided, two or more antennas 41 may be provided. Each of the plurality of antennas 41 may be provided in antenna stations geographically separated from each other.

The base station reception unit 42 receives the downlink signal from the mobile relay station 3 using the antenna 41. The base station reception unit 42 obtains waveform data of each of the reception antennas #1 to #N_{R} from the received downlink signal. The base station reception unit 42 outputs the obtained waveform data to the signal processing unit 43.

The signal processing unit 43 performs signal processing of LoRa (registered trademark). The signal processing unit 43 performs processing such as synchronization of waveform data of reception antennas #1 to #N_{R}, frame detection, compensation of a Doppler shift, compensation of a Doppler variation, reception beam control, and decoding. The Doppler variation is a variation per unit time of the Doppler shift. In the present embodiment, description of other reception processing performed by general wireless communication devices is omitted. The signal processing unit 43 includes a synchronization unit 44, a beam control unit 45, and a terminal signal decoding unit 46.

The synchronization unit 44 detects a frame in the waveform data of each of the reception antennas #1 to #N_{R} and compensates for a Doppler shift and a Doppler variation in the detected frame. The synchronization unit 44 synchronizes the frames of the reception antennas #1 to #N_{R} that have been compensated for and outputs the frames to the beam control unit 45. The synchronization unit 44 includes a timing detection unit 441, an estimation unit 442, and a compensation unit 443.

The timing detection unit 441 detects the timing of the frame in the waveform data of each of the reception antennas #1 to #N_{R}. Therefore, the timing detection unit 441 performs the sliding correlation processing between the waveform data and each of the plurality of types of first transmitted known signals. The first transmitted known signal is obtained by adding a frequency shift (first frequency shift) and a frequency variation (first frequency variation) to a first known signal section that is a part of the known signal section in the signal format of LoRa (registered trademark). The first transmitted known signal may be the entire known signal section in the signal format.

The plurality of types of first transmitted known signals are different in a set of frequency shift and frequency variation to be added. For example, the frequency shift can be a value in increments of Fstep1, and the frequency variation can be a value in increments of ΔFstep1. The first known signal section desirably includes an up-chirp section and a down-chirp section. A search range R1 of the set of the first frequency shift and the first frequency variation is a range of the Doppler shift and the Doppler variation that may be obtained from the orbital altitude of the LEO satellite equipped with the mobile relay station 3 and the transmission frequency of the uplink signal from the terminal station 2.

The timing detection unit 441 detects that the timing at which the correlation value is maximized in the waveform data is the start timing of the first known signal section in the signal format of LoRa (registered trademark). The timing detection unit 441 detects the frame head timing in the waveform data based on the detected start timing of the first known signal section and the position of the first known signal section in the signal format.

The estimation unit 442 fixes the frame head timing detected by the timing detection unit 441 for each of the reception antennas #1 to #N_{R} and specifies the frame section in the waveform data. The frame section is a section in which a terminal transmission frame of the uplink signal is included. The estimation unit 442 performs correlation processing between the second known signal section in the frame section of the specified waveform data and each of the plurality of types of second transmitted known signals. The second known signal section is a part or all of the known signal section in the signal format of LoRa (registered trademark). The second transmitted known signal is obtained by adding a frequency shift (second frequency shift) and a frequency variation (second frequency variation) to the second known signal section in the signal format of LoRa (registered trademark). It is desirable to use a section as long as possible as the second known signal. Therefore, the length of the second known signal is desirably equal to or longer than the length of the first known signal. The first known signal and the second known signal may be the same, different, or partially the same.

The plurality of types of second transmitted known signals are different in a set of frequency shift and frequency variation to be added. The frequency shift is obtained by dividing the range of the Doppler shift that can be taken in the search range R1 by Fstep2 of Fstep1 or less. The frequency variation is obtained by dividing the range of the Doppler variations that can be taken in a search range R1 by increments of ΔFstep2 that are equal to or smaller than ΔFstep1. In the case that the first known signal and the second known signal are identical to each other, Fstep2 is smaller than Fstep1, and ΔFstep2 is smaller than ΔFstep1. The estimation unit 442 obtains the frequency shift and the frequency variation added to the second transmitted known signal having the maximum correlation value as the estimation results of the Doppler shift and the Doppler variation received by the uplink signal.

The compensation unit 443 compensates for the Doppler shift and the Doppler variation estimated by the estimation unit 442 in the frame sections of the reception antennas #1 to #N_{R}. The compensation unit 443 outputs to the beam control unit 45 the waveform data of the frame sections of the reception antennas #1 to #N_{R} in which the Doppler shift and the Doppler variation are compensated.

The beam control unit 45 receives the waveform data of the frame sections of the reception antennas #1 to #N_{R} from the compensation unit 443 of the synchronization unit 44 and performs reception beam control. In the reception beam control, the beam control unit 45 multiplies the waveform data of the frame sections of the reception antennas #1 to #N_{R} by a weight for performing amplitude correction and phase correction for intensifying and combining the desired signals of the reception antennas while suppressing the interference signal, and then adds and combines the waveform data. The beam control unit 45 outputs the added and synthesized waveform data to the terminal signal decoding unit 46 as a received signal.

The terminal signal decoding unit 46 inputs the received signal obtained through the reception beam control from the beam control unit 45. The terminal signal decoding unit 46 decodes a symbol of the input received signal and obtains the terminal transmission data transmitted from the terminal station 2.

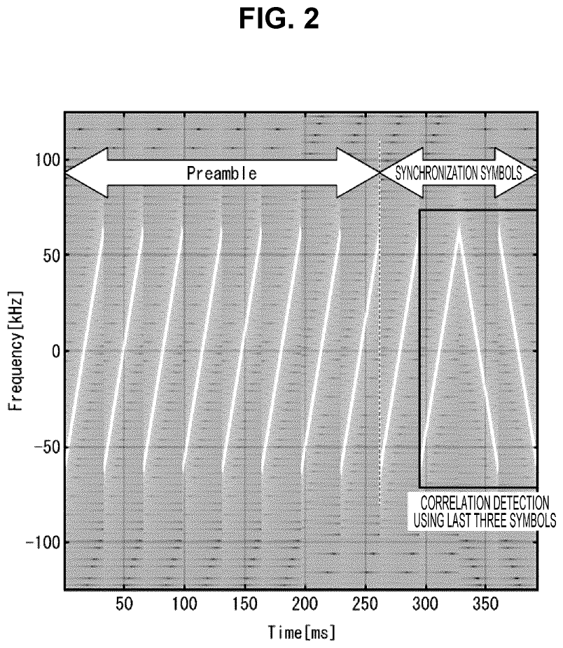

FIG. 2 is a diagram illustrating a known signal section included in a signal frame. The known signal section at the head of the LoRa (registered trademark) frame illustrated in FIG. 2 includes a preamble and synchronization symbols. The timing detection unit 441 of the base station 4 uses the first transmitted known signal in which the last three symbols of the synchronization symbol are used as the first known signal in the sliding correlation processing. These three symbols include an up-chirp section and a down-chirp section.

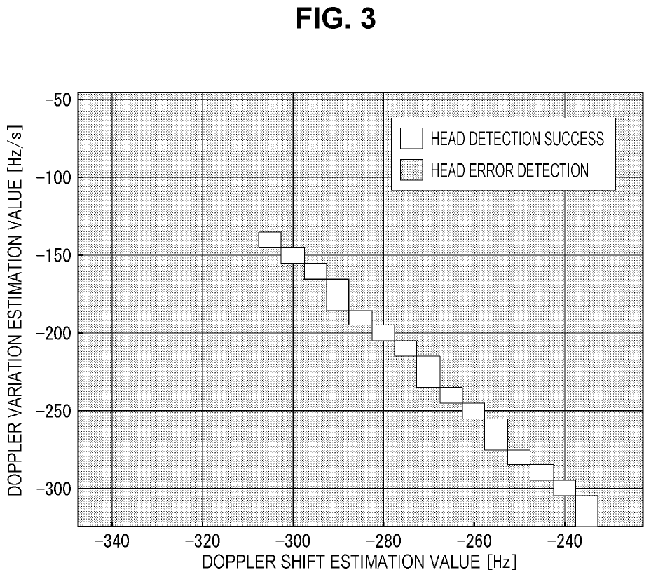

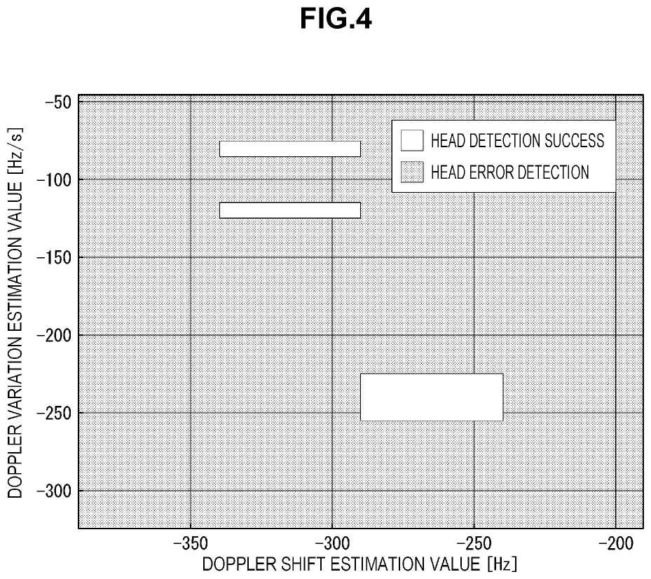

FIGS. 3 and 4 are diagrams illustrating whether the frame head timing is successfully detected. FIGS. 3 and 4 are diagrams illustrating whether the timing detection unit 441 has successfully detected the frame head timing as a result of performing the sliding correlation processing between the waveform data and the first transmitted known signal. The Doppler shift estimated value and the Doppler variation estimated value are values corresponding to the frequency shift and the frequency variation added to the first transmitted known signal, respectively. Here, the effect verification was performed with a LoRa (registered trademark) signal of −140 [dBm]. The correct answer of the Doppler shift of the received signal is −241 [Hz], and the correct answer of the Doppler variation is −301 [Hz/s]. In FIG. 3, a Doppler shift search step Fstep1 is set to 10 [Hz], and a Doppler variation search step ΔFstep1 is set to 5 [Hz/s]. In FIG. 4, the Doppler shift search step Fstep1 is set to 50 [Hz], and the Doppler variation search step ΔFstep1 is set to 10 [Hz/s]. As illustrated in FIG. 4, in the timing detection in the timing detection unit 441, it can be seen that the frame head timing in the waveform data can be accurately detected even at rough intervals such as 50 [Hz] in the Doppler shift search step Fstep1.

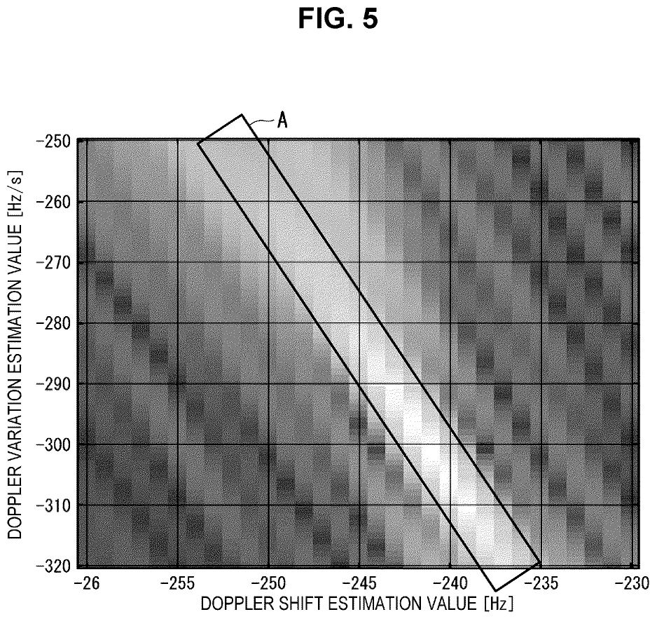

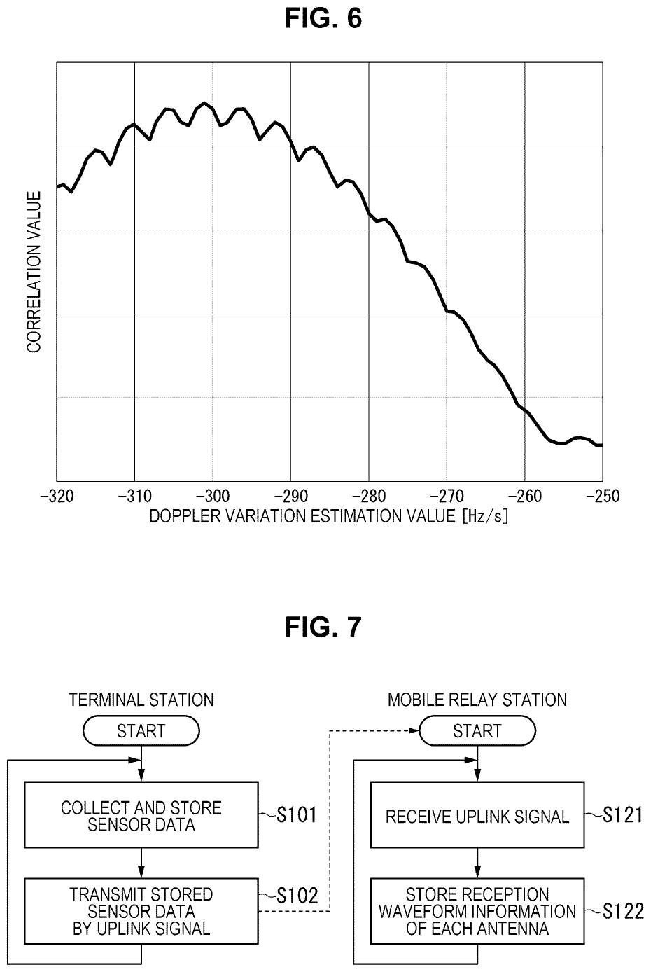

FIG. 5 is a diagram illustrating a search result of the Doppler shift compensation value and the Doppler variation compensation value after the frame head timing detection. FIG. 5 illustrates correlation values obtained by the estimation unit 442 performing correlation processing between the second known signal section in the frame and each of the plurality of types of second transmitted known signals while fixing the head timing of the frame detected based on the results illustrated in FIGS. 3 and 4. The Doppler shift estimated value and the Doppler variation estimated value are values corresponding to the frequency shift and the frequency variation added to the second transmitted known signal, respectively. In FIG. 5, a Doppler shift search step Fstep2 is set to 1 [Hz], and a Doppler variation search step ΔFstep2 is set to 1 [Hz/s]. In addition, FIG. 6 illustrates the maximum correlation value for each Doppler variation estimation value in a region A having a high correlation value in FIG. 5. As illustrated in FIG. 6, the correlation value is maximized at a value close to the correct answer Doppler variation. As described above, the Doppler shift compensation value and the Doppler variation compensation value can be searched with high accuracy using the longest possible section of the known signal section for the second known signal.

Subsequently, operations performed by the wireless communication system 1 will be described. FIG. 7 is a flowchart illustrating processing of the wireless communication system 1 in a case where the mobile relay station 3 receives an uplink signal. The terminal station 2 acquires data detected by a sensor, which is provided outside or inside and is not illustrated, at any time, and writes the acquired data in the transmission data storage unit 21 (step S101). The transmission unit 22 reads the sensor data as the terminal transmission data from the transmission data storage unit 21 at a transmission timing of the host station and wirelessly transmits the uplink signal with the terminal transmission data set from the antenna 23 (step S102). The terminal station 2 repeats the processing from step S101.

The reception units 32-1 to 32-N_{R} of the mobile relay station 3 receives the uplink signal transmitted from the terminal station 2 (step S121). Uplink signals at the same frequency may be simultaneously transmitted from a plurality of the terminal stations 2. In this case, the desired signals transmitted at the same frequency at the same time interfere with each other, but the signals are separated from each other by the reception beam control and can be received. The waveform sampling unit 33-n samples the waveforms of these uplink signals and writes, in the data storage unit 34, reception waveform information that associates waveform data representing the sampled waveforms, a reception clock time representing the sampling clock time, and reception antenna identification information representing the reception antenna #n (step S122). The mobile relay station 3 repeats the processing from step S121.

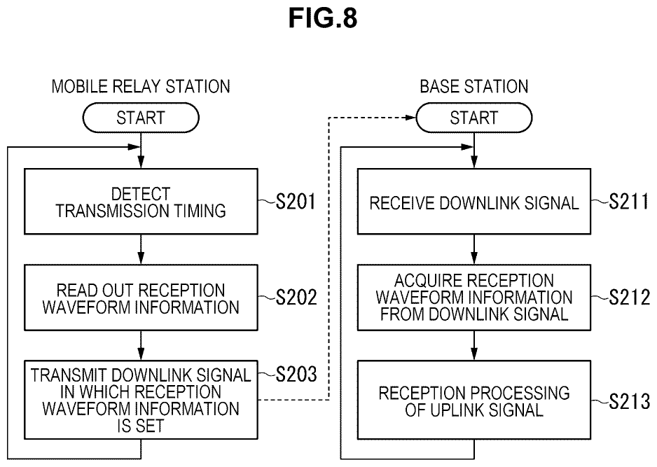

FIG. 8 is a flowchart illustrating processing of the wireless communication system 1 in a case where a downlink signal is transmitted from the mobile relay station 3. The base station communication unit 35 of the mobile relay station 3 detects that it is the transmission start timing stored in advance (step S201). The transmission start timing is calculated in advance based on the orbit information of the LEO satellite with the host station mounted thereon and the position of the base station 4, for example. The base station communication unit 35 reads reception waveform information as transmission data from the data storage unit 34 (step S202). The base station communication unit 35 transmits a downlink signal with the acquired transmission data set therein from the antenna 36 (step S203). The mobile relay station 3 repeats the processing from step S201.

The base station reception unit 42 of the base station 4 receives the downlink signal using the antenna 41 (step S211). The base station reception unit 42 demodulates and decodes the downlink signal to thereby obtain reception waveform information (step S212). The base station reception unit 42 outputs the waveform data of each of the reception antennas #1 to #N_{R} indicated by the reception waveform information to the signal processing unit 43. The signal processing unit 43 performs reception processing of the uplink signal indicated by the waveform data of the reception antennas #1 to #N_{R} and obtains terminal transmission data transmitted from the terminal station 2 (step S213). The base station 4 repeats the processing from step S211.

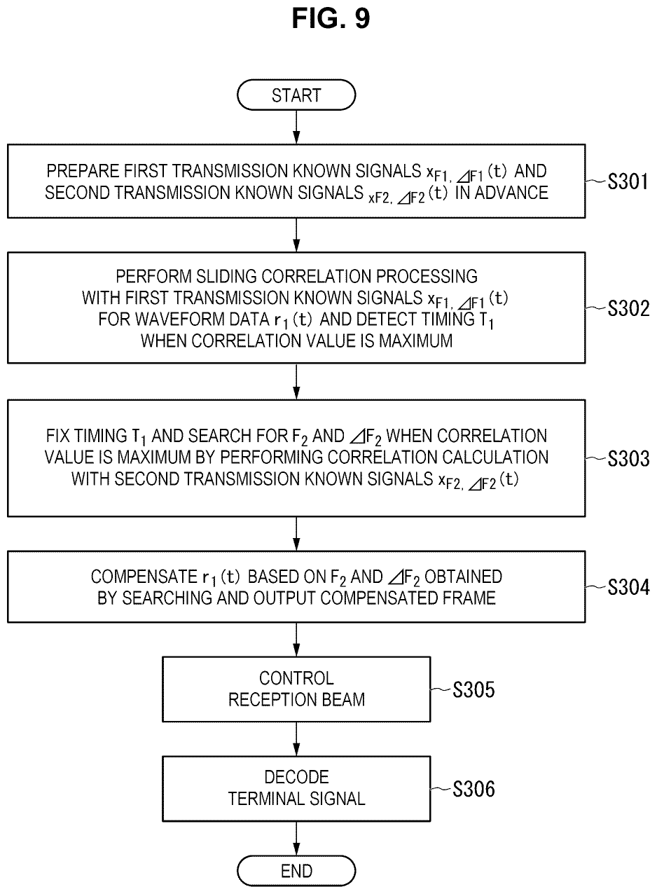

FIG. 9 is a flowchart illustrating processing in the signal processing unit 43 of the base station 4. The signal processing unit 43 performs the processing illustrated in FIG. 9 in step S213 of FIG. 8.

First, a plurality of types of first transmitted known signals x_{F1, ΔF1}(t) and a plurality of types of second transmitted known signals x_{F2, ΔF2}(t) are prepared in advance (step S301). The first transmitted known signals x_{F1, ΔF1}(t) are obtained by adding a frequency shift of F₁ [Hz] and a frequency variation of ΔF₁ [Hz/s] to the first known signal of the terminal uplink signal. As illustrated in FIG. 2, three consecutive synchronization symbols are used as the first known signal. The second transmitted known signals x_{F2, ΔF2}(t) are obtained by adding a frequency shift of F₂ [Hz] and a frequency variation of ΔF₂ [Hz/s] to the second known signal included in the terminal uplink signal.

In the different types of first transmitted known signals x_{F1, ΔF1}(t), the combination of a frequency shift F₁ and a frequency variation ΔF₁ added to the first known signal is different. For example, in a case where the range of the Doppler shift in the search range R1 is −dfₐ [Hz] to df_{b} [Hz], the frequency shift F₁ is obtained by dividing between −dfₐ [Hz] and df_{b} [Hz] in increments of Fstep1. In addition, in a case where the range of the Doppler variation in the search range R1 is −ΔFₐ [Hz/s] to −ΔF_{b} [Hz/s], a plurality of types of frequency variations ΔF₁ are obtained by dividing a range between ΔF_{b} [Hz/s] and ΔFₐ [Hz/s] in increments of ΔFstep1.

Similarly, in the different types of second transmitted known signals x_{F2, ΔF2}(t), the combination of the frequency shift F₂ and the frequency variation ΔF₂ added to the second known signal is different. For example, the plurality of types of frequency shifts F₂ can be obtained by dividing the range between −dfₐ [Hz] and df_{b}[Hz] in the search range R1 in increments of Fstep2 of Fstep1 or less. In addition, the plurality of types of frequency variations ΔF₂ is obtained by dividing the range between ΔF_{b} [Hz/s] and ΔFₐ [Hz/s] in the search range R1 in increments of ΔFstep2 of ΔFstep1 or less. As the second known signal, a section as long as possible among the known signal sections in the frame is used.

The synchronization unit 44 stores the first transmitted known signals x_{F1, ΔF1}(t) and the second transmitted known signals x_{F2, ΔF2}(t). In a case where the synchronization unit 44 has already stored these transmitted known signals, the processing of step S301 may not be performed. The synchronization unit 44 may generate first transmitted known signals x_{F1, ΔF1}(t) and second transmitted known signals x_{F2, ΔF2}(t) as required each time without preparing in advance.

The timing detection unit 441 performs the following processing on waveform data r₁(t) at the time t of each of the reception antennas #1 to #N_{R}. That is, the timing detection unit 441 performs the sliding correlation processing on the waveform data r₁(t) with each of the first transmitted known signals x_{F1, ΔF1}(t) corresponding to the combination of the frequency shift F₁ and the frequency variation ΔF₁. The timing detection unit 441 detects a frame head timing T₁ based on the start timing of the received signal waveform in the waveform data r₁(t) when the correlation value is maximum (step S302).

Subsequently, the estimation unit 442 fixes the timing T₁ detected in step S302, performs correlation calculation between the second known signal section of the waveform data r₁(t) and the second transmitted known signals x_{F2, ΔF2}(t), and searches for the frequency shift F₂ and the frequency variation ΔF₂ when the correlation value is maximum (step S303). Specifically, the estimation unit 442 performs the following processing on the waveform data r₁(t) of each of the reception antennas #1 to #N_{R}.

First, the estimation unit 442 sets the frame head timing in the waveform data r₁(t) as the timing T₁ detected by the timing detection unit 441, and specifies a frame section starting from the timing T₁. The frame section is a section including the terminal transmission frame of the uplink signal using LoRa (registered trademark) in the waveform data r₁(t).

The estimation unit 442 performs correlation processing between the second known signal section in the specified frame section and each of the second transmitted known signals x_{F2, ΔF2}(t) corresponding to the combination of the frequency shift F₂ and the frequency variation ΔF₂. The estimation unit 442 obtains the frequency shift F₂ and the frequency variation ΔF₂ added to the second transmitted known signals x_{F2, ΔF2} having the maximum correlation value as optimum values. The obtained frequency shift F₂ and frequency variation ΔF₂ are substantially the same as the Doppler shift and the Doppler variation received by the uplink signal of the desired signal, respectively.

The compensation unit 443 compensates for the frame sections of the reception antennas #1 to #N_{R} based on the optimum values of the frequency shift F₂ and the frequency variation ΔF₂ obtained in step S303 (step S304). That is, the compensation unit 443 compensates for the Doppler shift of the frequency shift F₂ obtained for the reception antenna #n in the frame section of the waveform data r₁(t) of the reception antenna #n. Further, the compensation unit 443 performs compensation for canceling the Doppler variation by adding phase rotation for canceling the Doppler variation of the frequency variation ΔF₂ obtained for the reception antenna #n over the entire frame section of the waveform data r₁(t) of the reception antenna #n. The compensation unit 443 outputs the waveform data of the frame sections of the reception antennas #1 to #N_{R} in which the Doppler shift and the Doppler variation are compensated to the beam control unit 45.

The compensation unit 443 may perform compensation on the frame sections of all the reception antennas #1 to #N_{R} using the frequency shift F₂ and the frequency variation ΔF₂ of the optimum values obtained for the reception antenna #n having the largest correlation value among the frequency shift F₂ and the frequency variation ΔF₂ obtained for each of the reception antennas #1 to #N_{R}.

The beam control unit 45 extracts a desired signal by performing reception beam control on the waveform data of the frame section of each of the reception antennas #1 to #N_{R} input from the synchronization unit 44 (step S305). The beam control unit 45 outputs the extracted desired signal to the terminal signal decoding unit 46.

The terminal signal decoding unit 46 performs decoding processing on the desired signal input from the beam control unit 45 to obtain terminal transmission data (step S306). The terminal signal decoding unit 46 outputs the obtained terminal transmission data.

According to the above embodiment, even in an environment where the Doppler variation is large, it is possible to synchronize the received signal since it is possible to decode the LoRa (registered trademark) modulation signal while suppressing the load of calculation.

### Second Embodiment

In the second embodiment, the calculation amount is reduced as compared with the first embodiment by limiting the next search range based on the result of timing detection. In the second embodiment, differences from the first embodiment will be mainly described.

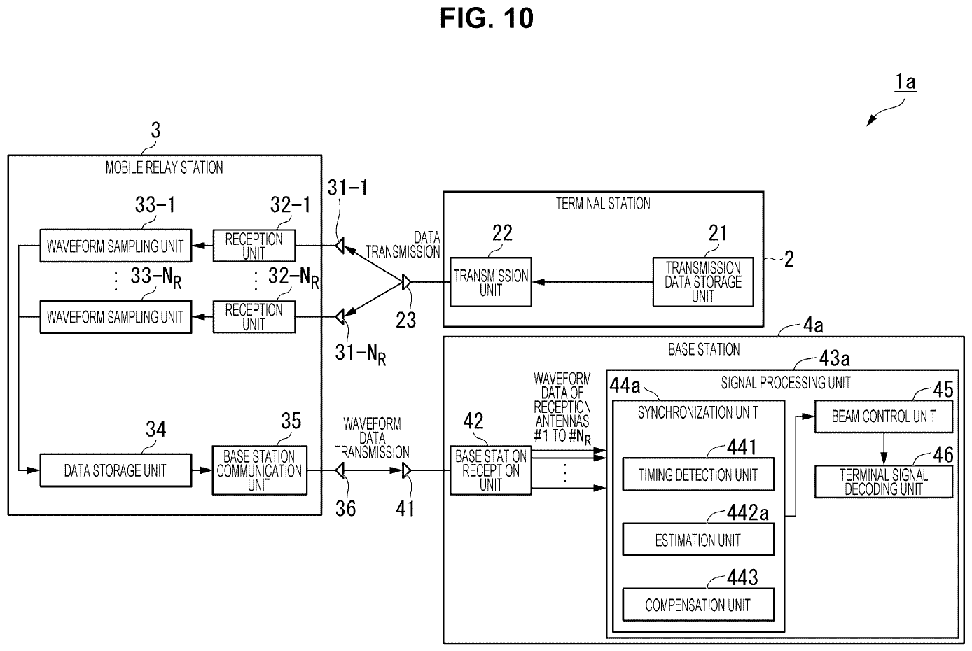

FIG. 10 is a diagram illustrating a configuration of a wireless communication system 1a according to the second embodiment. In FIG. 10, the same parts as those in the wireless communication system 1 according to the first embodiment in FIG. 1 will be denoted by the same reference signs, and description thereof will be omitted. The wireless communication system 1a illustrated in FIG. 10 is different from the wireless communication system 1 of the first embodiment illustrated in FIG. 1 in that a base station 4a is provided instead of the base station 4. The base station 4a includes the antenna 41, the base station reception unit 42, and a signal processing unit 43a. The signal processing unit 43a includes a synchronization unit 44a, the beam control unit 45, and the terminal signal decoding unit 46. The synchronization unit 44a includes the timing detection unit 441, an estimation unit 442a, and the compensation unit 443. The estimation unit 442a fixes the timing T₁ detected by the timing detection unit 441 and searches for the Doppler shift and the Doppler variation, and sets the search range as a search range R2 narrower than the search range R1 in the first embodiment.

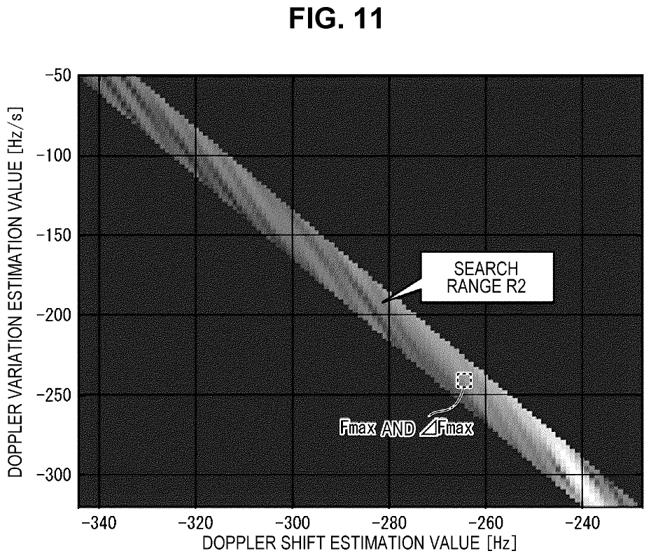

FIG. 11 is a diagram illustrating the search range R2 in the estimation unit 442a. The estimation unit 442a sets the frequency shift F₁ and the frequency variation ΔF₁ added to the first transmitted known signals x_{F1, ΔF1}(t) for which the maximum correlation value is obtained by the timing detection unit 441 as the Doppler shift Fmax and the Doppler variation ΔFmax, respectively. The estimation unit 442a determines the search range R2 based on the Doppler shift Fmax and the Doppler variation ΔFmax. Note that, similarly to the first embodiment, the Doppler shift search step Fstep2 is a value equal to or less than the Doppler shift search step Fstep1, and the Doppler variation search step ΔFstep2 is a value equal to or less than the Doppler variation search step ΔFstep1. In FIG. 11, Fstep2=1 [Hz] and ΔFstep2=1 [Hz/s] are established.

Tsync is a time from the head of the frame at the center of the synchronization symbol 3 symbols used for timing detection by the timing detection unit 441. The range of the Doppler shift in the search range R2 is determined by Formula (1) below according to the Doppler variation ΔFmax.

$$F max + ( Δ F max - Δ {F}_{1} ) \times ( {T}_{1} + T s y n c ) \pm 5 [ Hz ] \qquad ( 1 )$$

The Doppler variation range in the search range R2 is similar to the Doppler shift range in the search range R1.

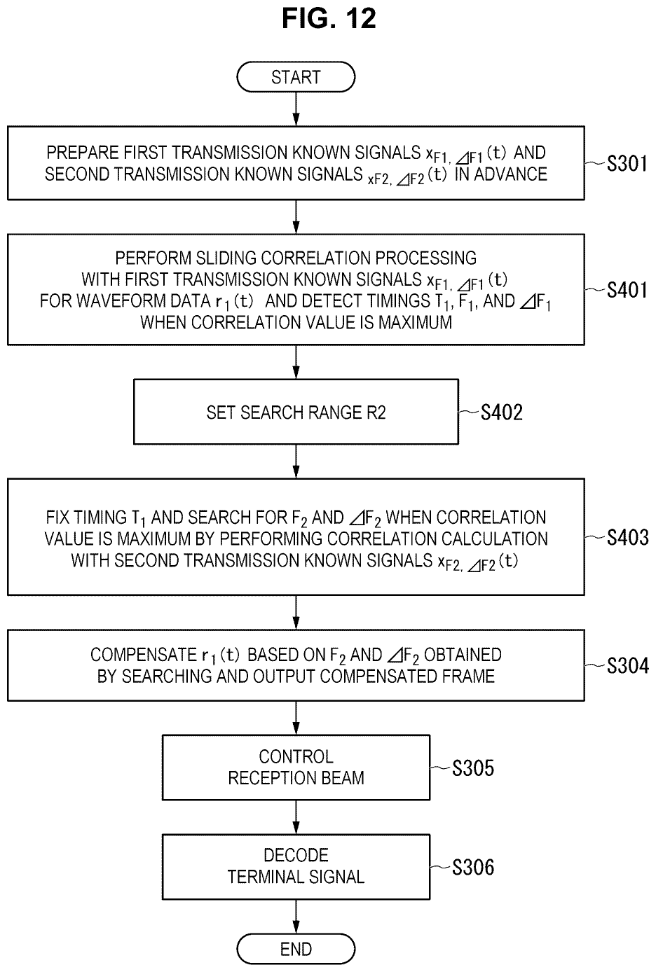

The wireless communication system 1a of the second embodiment performs processes similar to those in FIGS. 7 and 8. However, the wireless communication system 1a of the embodiment performs the processing illustrated in FIG. 12 in step S213 of FIG. 8. In FIG. 12, the same processing as that in the first embodiment in FIG. 9 will be denoted by the same reference signs, and detailed description thereof will be omitted.

FIG. 12 is a flowchart illustrating processing in the signal processing unit 43a of the base station 4a. First, the first transmitted known signals x_{F1, ΔF1}(t) and the second transmitted known signals x_{F2, ΔF2}(t) are prepared in advance (step S301). The synchronization unit 44a stores the first transmitted known signals x_{F1, ΔF1}(t) and the second transmitted known signals x_{F2, ΔF2}(t). Similarly to the first embodiment, as the second known signal used for the second transmitted known signals x_{F2, ΔF2}(t), the longest possible section of the known signal section in the frame is used. Note that the synchronization unit 44a may generate transmitted known signals as required each time without preparing the transmitted known signals in advance. In addition, in a case where the synchronization unit 44a has already stored these transmitted known signals, the processing of step S301 may not be performed.

The timing detection unit 441 performs the sliding correlation processing with the first transmitted known signals x_{F1, ΔF1}(t) on the waveform data r(t) at the time t of each of the reception antennas #1 to #N_{R}, and detects the timing T₁, the frequency shift F₁, and the frequency variation ΔF₁ when the correlation value is maximum (step S401). That is, the timing detection unit 441 performs the sliding correlation processing on the waveform data r₁(t) of each reception antenna #n with the first transmitted known signals x_{F1, ΔF1}(t) corresponding to the combination of the frequency shift F₁ and the frequency variation ΔF₁, similarly to the processing in step S302 in the first embodiment. The timing detection unit 441 detects a frame head timing T₁ based on the start timing of the received signal waveform in the waveform data r₁(t) when the correlation value is maximum. The timing detection unit 441 sets the frequency shift F₁ and the frequency variation ΔF₁ added to the first transmitted known signals x_{F1, ΔF1}(t) for which the maximum correlation value has been obtained as the Doppler shift Fmax and the Doppler variation ΔFmax, respectively.

The estimation unit 442a determines the search range R2 (step S402). Specifically, the estimation unit 442a determines the range of the Doppler shift in the search range R2 by Formula (1) using the Doppler shift Fmax and the Doppler variation ΔFmax obtained in step S401. The estimation unit 442a sets the Doppler variation range in the search range R2 to be the same as the Doppler variation range in the search range R1.

The estimation unit 442a performs processing similar to the processing in step S303 of FIG. 9 using the second transmitted known signals x_{F2, ΔF2}(t) corresponding to the number of combinations of the frequency shift F₂ and the frequency variation ΔF₂ in the search range R2 instead of the second transmitted known signals x_{F2, ΔF2}(t) corresponding to the number of combinations of the frequency shift F₂ and the frequency variation ΔF₂ in the search range R1 (step S403). The estimation unit 442a selects the second transmitted known signals x_{F2, ΔF2}(t) corresponding to the number of combinations of the frequency shift F₂ and the frequency variation ΔF₂ in the search range R2 from the second transmitted known signals x_{F2, ΔF2}(t) prepared in step S301. After the search range R2 is determined without preparing the second transmitted known signals x_{F2, ΔF2}(t) in step S301, the estimation unit 442a may generate the second transmitted known signals x_{F2, ΔF2}(t) using a set of the frequency shift F₂ and the frequency variation ΔF₂ in the search range R2.

The estimation unit 442a sets the frame head timing in the waveform data of each reception antenna #n to the timing T₁ detected by the timing detection unit 441 in step S401, and specifies a frame section starting from the timing T₁. The estimation unit 442a performs correlation processing between the second known signal section in the specified frame section and each of the plurality of types of second transmitted known signals x_{F2, ΔF2}(t) corresponding to the combination of the frequency shift F₂ and the frequency variation ΔF₂ in the search range R2. The estimation unit 442a obtains the frequency shift F₂ and the frequency variation ΔF₂ added to the second transmitted known signals x_{F2, ΔF2} having the maximum correlation value as optimum values. Processing of subsequent steps S304 to S306 is similar to that of the first embodiment illustrated in FIG. 9.

According to the second embodiment, since the range in which the estimation unit 442a performs detailed search is limited, the Doppler shift and the Doppler variation of the signal received by the mobile relay station 3 can be compensated for at a low load and at a high speed.

### Third Embodiment

In the third embodiment, the base station de-spreads any two symbols of the known signal section in the frame detected by the timing detection, and roughly estimates the Doppler variation and the Doppler shift based on the spectrum after the de-spreading processing, thereby limiting the search range. The third embodiment will be described by focusing on differences from the first and second embodiments.

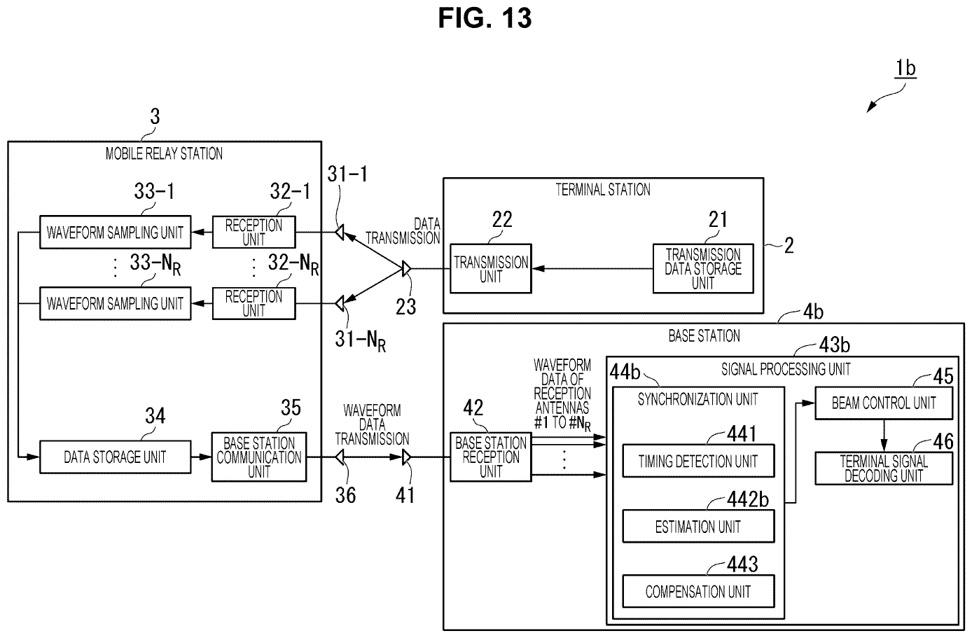

FIG. 13 is a diagram illustrating a configuration of a wireless communication system 1b according to the third embodiment. In FIG. 13, the same parts as those in the wireless communication system 1 according to the first embodiment in FIG. 1 will be denoted by the same reference signs, and description thereof will be omitted. The wireless communication system 1b illustrated in FIG. 13 is different from the wireless communication system 1b of the first embodiment illustrated in FIG. 1 in that a base station 4b is provided instead of the base station 4. The base station 4b includes the antenna 41, the base station reception unit 42, and a signal processing unit 43b. The signal processing unit 43b includes a synchronization unit 44b, the beam control unit 45, and the terminal signal decoding unit 46. The synchronization unit 44b includes the timing detection unit 441, an estimation unit 442b, and the compensation unit 443. The estimation unit 442b fixes the timing T₁ detected by the timing detection unit 441 and searches for the Doppler shift and the Doppler variation, and sets the search range as a search range R3 narrower than the search range R1 in the first embodiment.

The estimation unit 442b specifies a known signal section in the frame based on the frame head timing detected by the timing detection unit 441. The estimation unit 442b de-spreads any two symbols in the known signal section. These symbols are denoted by Y1 and Y2. The symbol Y1 appears before the symbol Y2. The estimation unit 442b detects the frequency with the power maximum based on the spectrum after the de-spreading of each of the symbol Y1 and the symbol Y2.

In the case of 2 times oversampling at a spreading factor (SF) 12, 1 symbol is 8192 samples. When Fast Fourier Transform (FFT) is simply performed in a section of one symbol, frequency resolution is low. Therefore, 0 is inserted after the 8193-th sample to increase the number of samples to be subjected to FFT so that the frequency resolution becomes about 1 Hz.

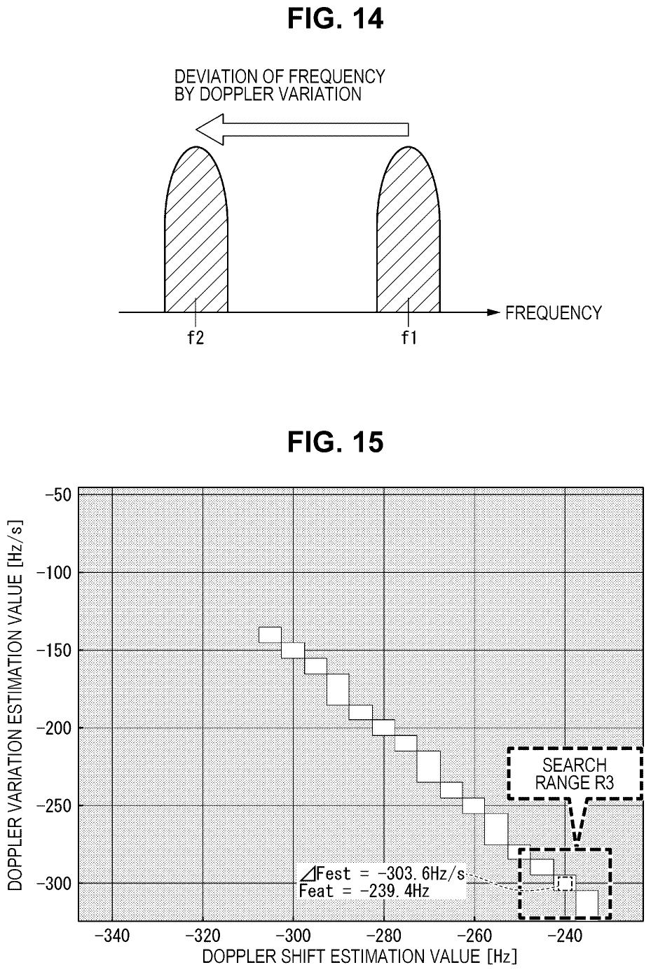

FIG. 14 is a diagram illustrating the frequency deviation of the symbol due to the Doppler shift. In a case where there is no Doppler variation, the frequency of the symbol Y1 and the frequency of the symbol Y2 are the same. However, due to the Doppler variation, a frequency shift occurs between the frequency f1 of the symbol Y1 and the frequency f2 of the symbol Y2. The estimation unit 442b roughly estimates the Doppler variation by Formula (2) using the difference between the power maximum frequency f1 of the symbol Y1 and the power maximum frequency f2 of the symbol Y2 and the time difference Δt between the symbol Y1 and the symbol Y2.

$$Δ Fest = ( f 2 - f 1 ) / ( Δ t ) \qquad ( 2 )$$

The estimation unit 442b obtains a Doppler shift rough estimation value Fest by the following Formula (3) using a Doppler variation rough estimation value ΔFest.

$$Fest = f 2 - Δ Fest \times ( {T}_{1} + Tsym 1 ) \qquad ( 3 )$$

In Formula (3), Tsym1 is the head timing of the symbol Y1 used for the rough estimation.

Note that a plurality of combinations of two target symbols may be provided, and the estimation unit 442b may take an average of each of the Doppler variation rough estimation value ΔFest and the Doppler shift rough estimation value Fest obtained for each of the combinations. Furthermore, the estimation unit 442b may take an average of each of the Doppler variation rough estimation value ΔFest and the Doppler shift rough estimation value Fest obtained for the waveform data of each of the reception antennas #1 to #N_{R}. By taking the averages thereof, the influence of thermal noise can be reduced, and the accuracy of rough estimation of the Doppler shift and the Doppler variation can be improved.

FIG. 15 is a diagram illustrating the search range R3. The estimation unit 442b sets the range of ΔFest±several tens of [Hz/s] and the range of Fest±about 10 [Hz] as the search range R3. Furthermore, the estimation unit 442b performs detailed search at intervals of, for example, ΔFstep2=1 [Hz/s] and Fstep2=1 [Hz]. FIG. 15 illustrates the search range R3 in a case where the Doppler variation rough estimation value ΔFest is −303.6 [Hz/s] and the Doppler shift rough estimation value Fest=−239.4 [Hz].

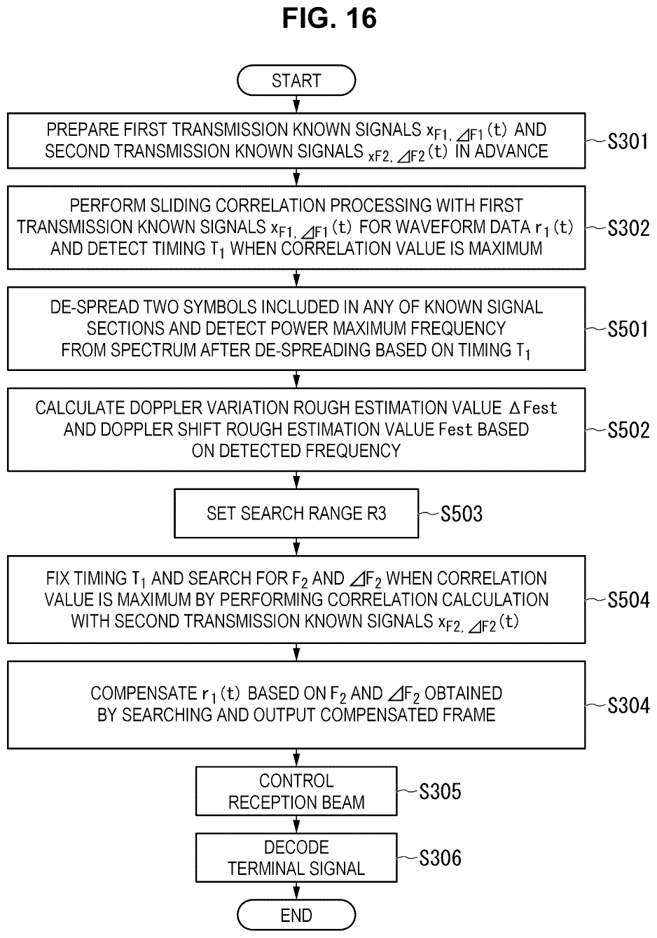

A wireless communication system 1c of the third embodiment performs processes similar to those in FIGS. 7 and 8. However, the wireless communication system 1c performs the processing illustrated in FIG. 16 in step S213 of FIG. 8. In FIG. 16, the same processing as that in the first embodiment in FIG. 9 will be denoted by the same reference signs, and detailed description thereof will be omitted.

FIG. 16 is a flowchart illustrating processing in the signal processing unit 43b of the base station 4b. First, the first transmitted known signals x_{F1, ΔF1}(t) and the second transmitted known signals x_{F2, ΔF2}(t) are prepared in advance (step S301). The synchronization unit 44b stores the first transmitted known signals x_{F1, ΔF1}(t) and the second transmitted known signals x_{F2, ΔF2}(t). Similarly to the first embodiment, as the second known signal used for the second transmitted known signals x_{F2, ΔF2}(t), the longest possible section of the known signal section in the frame is used. Note that the synchronization unit 44b may generate transmitted known signals as required each time without preparing the transmitted known signals in advance. In addition, in a case where the synchronization unit 44b has already stored these transmitted known signals, the processing of step S301 may not be performed.

The timing detection unit 441 performs the sliding correlation processing with the first transmitted known signals x_{F1, ΔF1}(t) on the waveform data r₁(t) at the time t of each of the reception antennas #1 to #N_{R} to detect the frame head timing T₁ (step S302).

The estimation unit 442b sets the frame head timing in the waveform data of each reception antenna #n to the timing T₁ detected by the timing detection unit 441 in step S302, and specifies a frame section starting from the timing T₁. The estimation unit 442b de-spreads the symbol Y1 and the symbol Y2 included in the known signal section in the frame, and detects the power maximum frequency f1 of the symbol Y1 and the power maximum frequency f2 of the symbol Y2 based on the spectrum after de-spreading (step S501).

The estimation unit 442b calculates the Doppler variation rough estimation value ΔFest by Formula (2) using the power maximum frequency f1 of the symbol Y1 and the power maximum frequency f2 of the symbol Y2. Further, the estimation unit 442b calculates the Doppler shift rough estimation value Fest by Formula (3) using the Doppler variation rough estimation value ΔFest (step S502). The estimation unit 442b sets the range of ΔFest±several tens of [Hz/s] and the range of Fest±about 10 [Hz] as the search range R3 (step S503).

The estimation unit 442b performs processing similar to the processing in step S303 of FIG. 9 using the second transmitted known signals x_{F2, ΔF2}(t) corresponding to the number of combinations of the frequency shift F₂ and the frequency variation ΔF₂ in the search range R3 instead of the second transmitted known signals x_{F2, ΔF2}(t) corresponding to the number of combinations of the frequency shift F₂ and the frequency variation ΔF₂ in the search range R1 (step S504). The estimation unit 442b selects the second transmitted known signals x_{F2, ΔF2}(t) corresponding to the number of combinations of the frequency shift F₂ and the frequency variation ΔF₂ in the search range R3 from the second transmitted known signals x_{F2, ΔF2}(t) prepared in step S301. After the search range R3 is determined without preparing the second transmitted known signals x_{F2, ΔF2}(t) in step S301, the estimation unit 442b may generate the second transmitted known signals x_{F2, ΔF2}(t) using a set of the frequency shift F₂ and the frequency variation ΔF₂ in the search range R3.

The estimation unit 442b performs correlation processing between the second known signal section in the frame section of the waveform data of each reception antenna #n and each of the second transmitted known signals x_{F2, ΔF2}(t) corresponding to the combination of the frequency shift F₂ and the frequency variation ΔF₂ in the search range R3. The estimation unit 442b obtains the frequency shift F₂ and the frequency variation ΔF₂ added to the second transmitted known signals x_{F2, ΔF2} having the maximum correlation value as optimum values. Processing of subsequent steps S304 to S306 is similar to that of the first embodiment illustrated in FIG. 9.

According to the third embodiment, since the range in which the estimation unit 442b performs detailed search is limited, the Doppler shift and the Doppler variation of the signal received by the mobile relay station 3 can be compensated for at a low load and at a high speed.

### Fourth Embodiment

In the fourth embodiment, by setting the logical product of the search range R2 of the second embodiment and the search range R3 of the third embodiment as the search range, the search range is further limited as compared with the second embodiment and the third embodiment, and the calculation amount is reduced. In the fourth embodiment, differences from the first to third embodiments will be mainly described.

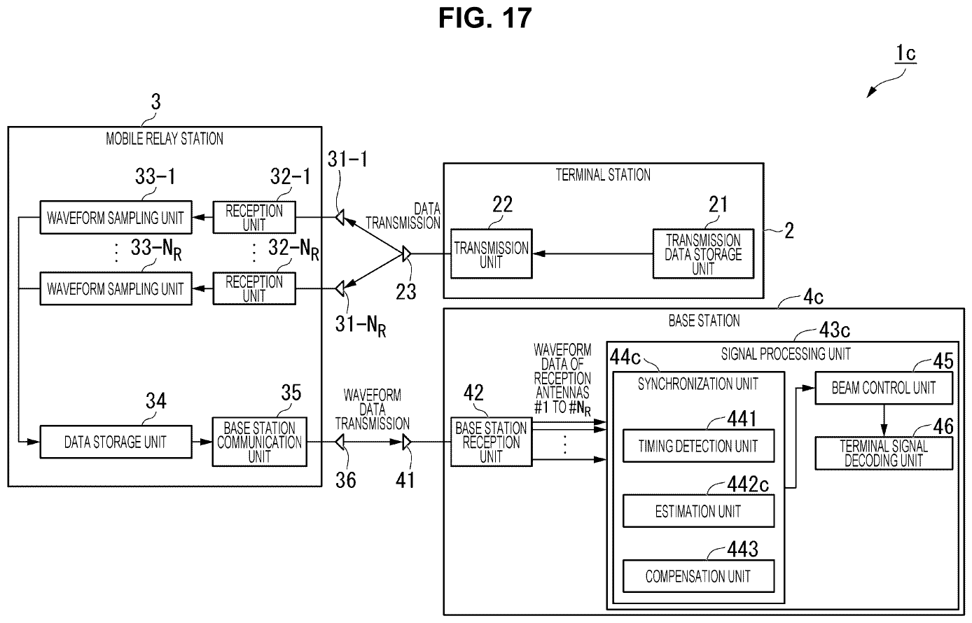

FIG. 17 is a diagram illustrating a configuration of the wireless communication system 1c according to the fourth embodiment. In FIG. 10, the same parts as those in the wireless communication system 1 according to the first embodiment in FIG. 1 will be denoted by the same reference signs, and description thereof will be omitted. The wireless communication system 1c illustrated in FIG. 17 is different from the wireless communication system 1 of the first embodiment illustrated in FIG. 1 in that a base station 4c is provided instead of the base station 4. The base station 4c includes the antenna 41, the base station reception unit 42, and a signal processing unit 43c. The signal processing unit 43c includes a synchronization unit 44c, the beam control unit 45, and the terminal signal decoding unit 46. The synchronization unit 44c includes the timing detection unit 441, an estimation unit 442c, and the compensation unit 443.

The estimation unit 442c sets a logical product of the search range R2 calculated similarly to the estimation unit 442a of the second embodiment and the search range R3 calculated similarly to the estimation unit 442b of the third embodiment as a search range R4. The estimation unit 442c fixes the timing T₁ detected by the timing detection unit 441 and performs correlation processing between the waveform data of each reception antenna #Rn and the second transmitted known signal to which the combination of the frequency shift and the frequency variation in the search range R4 is added. For example, the estimation unit 442c searches the search range R4 in detail at intervals of Fstep2=1 [Hz] and ΔFstep2=1 [Hz/s].

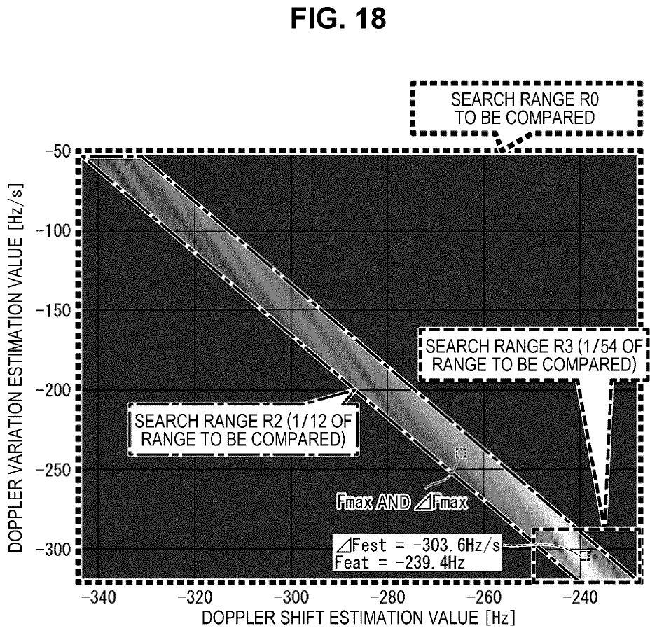

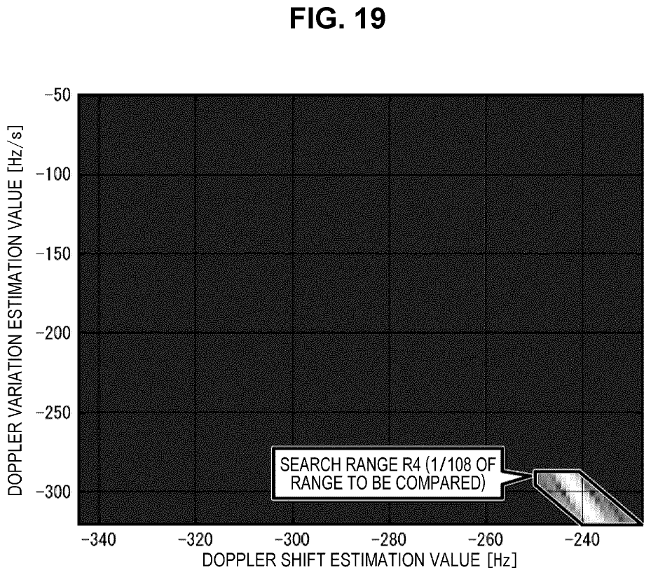

FIG. 18 is a diagram illustrating the search range R2 and the search range R3, and FIG. 19 is a diagram illustrating the search range R4. The search range R2 illustrated in FIG. 18 is similar to that in FIG. 11, and is 1/12 of the search range R0 to be compared. In addition, the search range R3 illustrated in FIG. 18 is similar to that in FIG. 15, and is 1/54 of the search range R0 to be compared. The search range R0 to be compared is, for example, the search range R1. The search range R4, which is a range of a logical product (AND) of the search range R2 and the search range R3 illustrated in FIG. 19, is 1/108 of the search range R0 to be compared. As described above, in the present embodiment, the search range is greatly reduced.

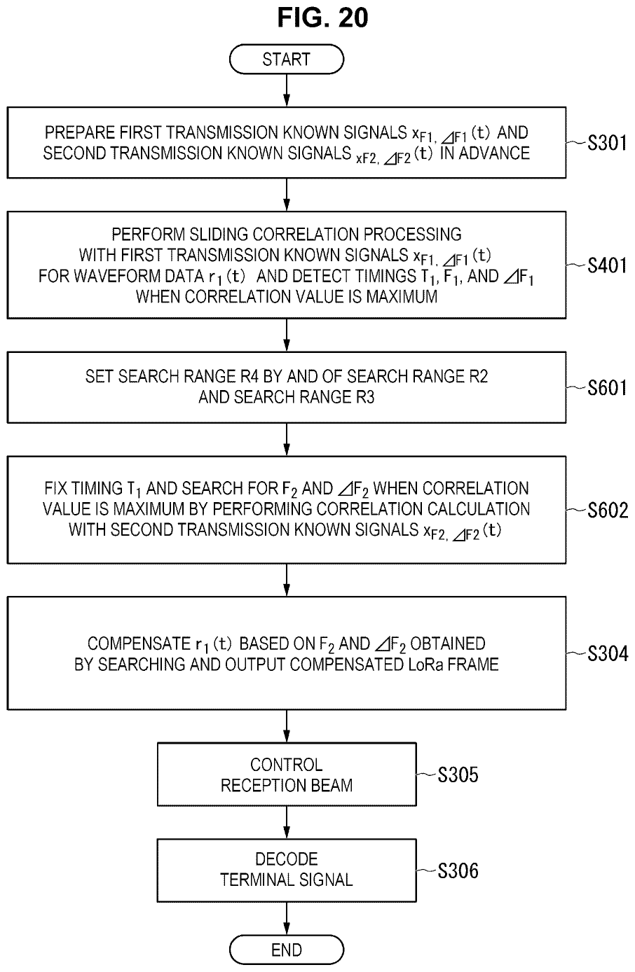

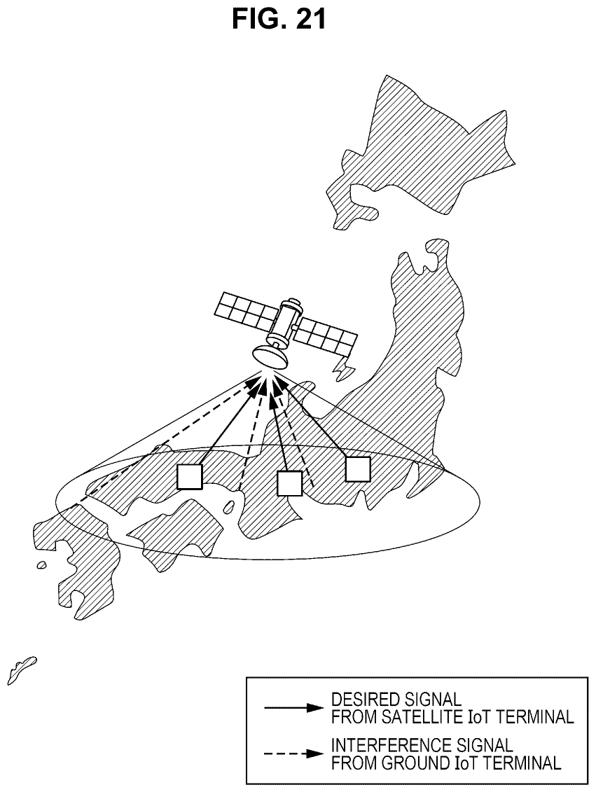

The wireless communication system 1c of the fourth embodiment performs processes similar to those in FIGS. 7 and 8. However, the wireless communication system 1c of the embodiment performs the processing illustrated in FIG. 20 in step S213 of FIG. 8. In FIG. 20, the same processing as the processing according to the first embodiment illustrated in FIG. 9 and the same processing as the processing according to the second embodiment illustrated in FIG. 12 are denoted by the same reference numerals, and a detailed description thereof will be omitted.

FIG. 20 is a flowchart illustrating processing in the signal processing unit 43c of the base station 4c. First, the first transmitted known signals x_{F1, ΔF1}(t) and the second transmitted known signals x_{F2, ΔF2}(t) are prepared in advance (step S301). The synchronization unit 44c stores the first transmitted known signals x_{F1, ΔF1}(t) and the second transmitted known signals x_{F2, ΔF2}(t). Similarly to the first embodiment, as the second known signal used for the second transmitted known signals x_{F2, ΔF2}(t), the longest possible section of the known signal section in the frame is used. Note that the synchronization unit 44c may generate o transmitted known signals as required each time without preparing the transmitted known signals in advance. In addition, in a case where the synchronization unit 44c has already stored these transmitted known signals, the processing of step S301 may not be performed.

The timing detection unit 441 performs the sliding correlation processing with the first transmitted known signals x_{F1, ΔF1}(t) on the waveform data r₁(t) at the time t of each of the reception antennas #1 to #N_{R}, and detects the timing T₁, the frequency shift F₁, and the frequency variation ΔF₁ when the correlation value is maximum (step S401).

The estimation unit 442c determines the search range R2 by processing similar to step S402 of the second embodiment illustrated in FIG. 12. Furthermore, the estimation unit 442c determines the search range R3 by processing similar to steps S501 to S503 of the third embodiment illustrated in FIG. 16. The estimation unit 442c obtains a search range R4 by a logical product (AND) of the search range R2 and the search range R3 (step S601).

The estimation unit 442c performs processing similar to that in step S303 in FIG. 9 using the second transmitted known signals x_{F2, ΔF2}(t) corresponding to the number of combinations of the frequency shift F₂ and the frequency variation ΔF₂ in the search range R4 (step S602). The estimation unit 442c selects the second transmitted known signals x_{F2, ΔF2}(t) corresponding to the number of combinations of the frequency shift F₂ and the frequency variation ΔF₂ in the search range R4 from the second transmitted known signals x_{F2, ΔF2}(t) prepared in step S301, but may generate the second transmitted known signals x_{F2, ΔF2}(t) using a set of the frequency shift F₂ and the frequency variation ΔF₂ in the search range R4 after the search range R4 is determined. The estimation unit 442c obtains the frequency shift F₂ and the frequency variation ΔF₂ added to the second transmitted known signals x_{F2, ΔF2} having the maximum correlation value as optimum values. Processing of subsequent steps S304 to S306 is similar to that of the first embodiment illustrated in FIG. 9.

According to the fourth embodiment, since the range in which the estimation unit 442c performs detailed search is limited, the Doppler shift and the Doppler variation of the signal received by the mobile relay station 3 can be compensated for at a low load and at a high speed.

In the above-described embodiments, the case where the moving body on which the mobile relay station is mounted is an LEO satellite has been described. However, the mobile object may be another flying object that flies through the sky, such as a geostationary satellite, a drone, or a HAPS. Further, the above embodiments are also applicable to a case where a relay station that does not move receives a wireless signal from a terminal station that moves on a predetermined orbit, for example.

According to the embodiment described above, even under an environment with a large Doppler variation, synchronization for decoding a wireless signal can be performed while suppressing a calculation load.

All or some of the signal processing unit 43 of the base station 4, the signal processing unit 43a of the base station 4a, the signal processing unit 43b of the base station 4b, and the signal processing unit 43c of the base station 4c may be realized by a processor such as a central processing unit (CPU) or a graphics processing unit (GPU) reading and executing a program from a storage unit. In addition, all or some of the functions of the signal processing unit 43 of the base station 4, the signal processing unit 43a of the base station 4a, the signal processing unit 43b of the base station 4b, and the signal processing unit 43c of the base station 4c may be realized by using hardware such as an application specific integrated circuit (ASIC), a programmable logic device (PLD), or a field programmable gate array (FPGA).

In addition, the base station 4 may not include the signal processing unit 43, and a signal processing device connected to the base station 4 may include the signal processing unit 43. In addition, the base station 4a may not include the signal processing unit 43a, and a signal processing device connected to the base station 4a may include the signal processing unit 43a. In addition, the base station 4b may not include the signal processing unit 43b, and a signal processing device connected to the base station 4b may include the signal processing unit 43b. In addition, the base station 4c may not include the signal processing unit 43c, and a signal processing device connected to the base station 4c may include the signal processing unit 43c.

According to the above-described embodiment, the signal processing device includes a timing detection unit, an estimation unit, and a compensation unit. The signal processing device corresponds to, for example, the base stations 4, 4a, 4b, and 4c in the embodiment. The timing detection unit detects the timing of the frame in the waveform data based on the sliding correlation between each of the plurality of types of first transmitted known signals obtained by adding different combinations of the first frequency shift corresponding to the Doppler shift and the first frequency variation corresponding to the Doppler variation that is the time variation of the Doppler shift to the first known signal and the waveform data representing the waveform of the received signal in the communication device. The communication device corresponds to, for example, the mobile relay station 3 of the embodiment. The estimation unit estimates the Doppler shift and the Doppler variation received by the received signal based on correlation calculation between each of a plurality of types of second transmitted known signals obtained by adding different combinations of the second frequency shift corresponding to the Doppler shift and the second frequency variation corresponding to the Doppler variation to the second known signal and the second known signal in the waveform data specified by the detected timing. The compensation unit compensates for the estimated Doppler shift and Doppler variation with respect to the waveform data.

In addition, according to the above-described embodiments, a wireless communication system includes a transmission device, a relay device, and a reception device. For example, the transmission device corresponds to the terminal station 2 in the embodiment, the relay device corresponds to the mobile relay station 3 in the embodiment, and the reception device corresponds to the base stations 4, 4a, 4b, and 4c in the embodiment. The relay device includes a relay unit that receives a signal wirelessly transmitted from the transmission device and transmits waveform data indicating a waveform of the received signal to the reception device. For example, the relay unit corresponds to the reception units 32-1 to 32-N_{R}, the waveform sampling unit 33-1 to 33-N_{R}, the data storage unit 34, and the base station communication unit 35 of the embodiment. The reception device includes a reception unit that receives waveform data from the relay device, a timing detection unit similar to the signal processing device described above, an estimation unit, and a compensation unit. For example, the reception unit corresponds to the base station reception unit 42 of the embodiment.

A deviation between the adjacent first frequency shifts may be larger than a deviation between the adjacent second frequency shifts, and a deviation between the adjacent first frequency variations may be larger than a deviation between the adjacent second frequency variations.

The first known signal may include an up-chirp section and a down-chirp section. The second known signal may be longer than the first known signal.

The estimation unit may limit the search range of the combination of the second frequency shift and the second frequency variation based on the first frequency shift and the first frequency variation added to the first transmitted known signal having the largest correlation value of the sliding correlation. The estimation unit performs correlation calculation using a plurality of types of second transmitted known signals to which different combinations of the second frequency shift and the second frequency variation included in the limited search range are added.

The estimation unit may detect a power maximum frequency for each of a first symbol and a second symbol based on a spectrum obtained by de-spreading the first symbol and the second symbol in the known signal section in the waveform data specified by the detected timing, roughly estimate a Doppler variation using the detected frequency difference and a timing difference between the first symbol and the second symbol, and limit a search range of a combination of a second frequency shift and a second frequency variation based on the roughly estimated Doppler variation and a roughly estimated Doppler shift using the roughly estimated Doppler variation. The estimation unit performs correlation calculation using second transmitted known signals to which different combinations of the second frequency shift and the second frequency variation included in the limited search range are added.

In addition, at least some of the functions of the signal processing device and the reception device may be implemented by a computer. In that case, the function of the signal processing device and the function of the reception device may be realized by recording a program for realizing the function of the signal processing device and the function of the reception device in a computer-readable recording medium, and causing a computer system to read and execute the program recorded in the recording medium. Assume that the computer system includes, for example, a processor, an OS, and hardware such as peripheral devices. The program of the signal processing device and the program of the reception device may be recorded in a computer-readable recording medium. The computer-readable recording medium is, for example, a portable medium such as a flexible disk, a magneto-optical disk, a ROM, or a CD-ROM, or a storage device such as a hard disk built in a computer system. The program of the signal processing device and the program of the reception device may be transmitted via a telecommunication line.

Although the embodiment of the present invention has been described in detail with reference to the drawings, the specific configuration is not limited to the embodiment, and includes design, and the like, within a range not departing from the gist of the present invention.

### REFERENCE SIGNS LIST

1, 1a, 1b, 1c Wireless communication system
2 Terminal station
3 Mobile relay station
4, 4a, 4b, 4c Base station
21 Transmission data storage unit
22 Transmission unit
31-1 to 31-N_{R}, 36 Antenna
32-1 to 32-N_{R} Reception unit
33-1 to 33-N_{R} Waveform sampling unit
34 Data storage unit
35 Base station communication unit
41 Antenna
42 Base station reception unit
43, 43a, 43b, 43c Signal processing unit
44, 44a, 44b, 44c Synchronization unit
45 Beam control unit
46 Terminal signal decoding unit
441 Timing detection unit
442, 442a, 442b, 442c Estimation unit
443 Compensation unit

1. A signal processing device comprising:
a timing detection circuitry that detects a timing of a frame in waveform data based on a sliding correlation between each of a plurality of types of first transmitted known signals obtained by adding different combinations of a first frequency shift corresponding to a Doppler shift and a first frequency variation corresponding to a Doppler variation that is a time variation of the Doppler shift to a first known signal and the waveform data representing a waveform of a received signal in a communication device;
an estimation circuitry that estimates a Doppler shift and a Doppler variation received by the received signal based on correlation calculation between each of a plurality of types of second transmitted known signals obtained by adding different combinations of a second frequency shift corresponding to a Doppler shift and a second frequency variation corresponding to a Doppler variation to a second known signal and the second known signal in the waveform data specified by the detected timing; and
a compensation circuitry that compensates for the Doppler shift and the Doppler variation estimated for the waveform data.

2. The signal processing device according to claim 1, wherein a deviation between the adjacent first frequency shifts is larger than a deviation between the adjacent second frequency shifts, and a deviation between the adjacent first frequency variations is larger than a deviation between the adjacent second frequency variations.

3. The signal processing device according to claim 1, wherein
the first known signal includes an up-chirp section and a down-chirp section, and
the second known signal is a section longer than the first known signal.

4. The signal processing device according to claim 1, wherein
the estimation circuitry limits a search range of a combination of a second frequency shift and a second frequency variation based on the first frequency shift and the first frequency variation added to the first transmitted known signal having a maximum correlation value of the sliding correlation, and performs the correlation calculation using the plurality of types of the second transmitted known signals to which different combinations of the second frequency shift and the second frequency variation included in the limited search range are added.

5. The signal processing device according to claim 1, wherein the estimation circuitry detects a power maximum frequency for each of a first symbol and a second symbol based on a spectrum obtained by de-spreading the first symbol and the second symbol in the known signal section in the waveform data specified by the detected timing, roughly estimates a Doppler variation using the detected frequency difference and a timing difference between the first symbol and the second symbol, limits a search range of a combination of a second frequency shift and a second frequency variation based on the roughly estimated Doppler variation and a roughly estimated Doppler shift using the roughly estimated Doppler variation, and performs the correlation calculation using a plurality of types of the second transmitted known signals to which different combinations of the second frequency shift and the second frequency variation included in the limited search range are added.

6. A wireless communication system comprising:
a transmission device;
a relay device; and
a reception device, wherein
the relay device includes
a relay circuitry that receives a signal wirelessly transmitted from the transmission device and transmits waveform data indicating a waveform of the received signal to the reception device, and
the reception device includes
a reception circuitry that receives the waveform data,
a timing detection circuitry that detects a timing of a frame in the waveform data based on a sliding correlation between each of a plurality of types of first transmitted known signals obtained by adding different combinations of a first frequency shift corresponding to a Doppler shift and a first frequency variation corresponding to a Doppler variation that is a time variation of the Doppler shift to the first known signal and the waveform data,
an estimation circuitry that estimates a Doppler shift and a Doppler variation received by the received signal based on correlation calculation between each of a plurality of types of second transmitted known signals obtained by adding different combinations of a second frequency shift corresponding to a Doppler shift and a second frequency variation corresponding to a Doppler variation to a second known signal and the second known signal in the waveform data specified by the detected timing, and
a compensation circuitry that compensates for the Doppler shift and the Doppler variation estimated for the waveform data.

7. A signal processing method comprising:
detecting a timing of a frame in waveform data based on a sliding correlation between each of a plurality of types of first transmitted known signals obtained by adding different combinations of a first frequency shift corresponding to a Doppler shift and a first frequency variation corresponding to a Doppler variation that is a time variation of the Doppler shift to a first known signal and the waveform data representing a waveform of a received signal in a communication device;
estimating a Doppler shift and a Doppler variation received by the received signal based on correlation calculation between each of a plurality of types of second transmitted known signals obtained by adding different combinations of a second frequency shift corresponding to a Doppler shift and a second frequency variation corresponding to a Doppler variation to a second known signal and the second known signal in the waveform data specified by the detected timing; and
compensating for Doppler shift and the Doppler variation estimated for the waveform data.

8. (canceled)
